(19) United States
(12) Patent Application Publication
(10) Pub. No.: US 2019/0179100 A1
(43) Pub. Date: Jun. 13, 2019

(54) Camera lens

(71) Applicant: AAC Technologies Pte. Ltd., Singapore city (SG)

(72) Inventor: Chuandong Wei, Shenzhen (CN)

(21) Appl. No.: 16/112,927

(22) Filed: Aug. 27, 2018

(30) Foreign Application Priority Data
Dec. 8, 2017 (CN) 201721709013.1

(51) Int. Cl. G02B 7/02

(52) U.S. Cl. CPC G02B 7/021; G02B 7/026

(57) ABSTRACT

The present application discloses a camera lens. The camera lens includes a lens holder and a lens group accommodated in the lens holder. The lens group includes a first lens unit. The lens holder includes a first holder and a second holder covering the first lens holder and having a light aperture. The first and second holders form an accommodation space for receiving the first lens unit therein. The first lens unit includes an object side surface adjacent to the light aperture, and the first holder or the second holder abuts against the object side surface of the first lens unit. The first holder includes a first complementary configuration, and the second holder includes a second complementary configuration for engaging with the first complementary configuration.

### FIELD OF THE PRESENT DISCLOSURE

The present disclosure relates to a lens module for capturing image, and more particularly to a lens module having a configuration enabling high efficient assembly.

### DESCRIPTION OF RELATED ART

With development of technology, besides digital cameras, more and more portable electronic devices are equipped with image capturing functions. To achieve the image capturing function, a camera module is needed. Generally, a camera module includes a camera lens for collecting light reflected from an object, a sensor for receiving the light and converting the light to electrical signals, and processor for calculating the signals and outputting digital images.

Such a camera lens includes a lens holder, a plurality of lens units positioned in the lens holder, a plurality of shading plates located between two adjacent lens units, and a pressing ring located between a last lens unit and the lens holder for positioning the lens units. Typically, the pressing ring is attached to the lens holder by adhering. In the related camera lens, however, the lens holder is made from a single kind of material, and the aperture for letting light enter the camera lens is fixed, which makes it difficult or inflexible to assemble the lens units.

Therefore, it is desired that an improved camera lens can be developed to overcome the disadvantages mentioned above.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is an illustrative cross-sectional view of a camera lens in accordance with a first exemplary embodiment of the present invention.

FIG. 2 is an exploded view of the camera lens in FIG. 1.

FIG. 3 is an illustrative cross-sectional view of a camera lens in accordance with a second exemplary embodiment of the present invention.

FIG. 4 is an exploded view of the camera lens in FIG. 3.

FIG. 5 is an illustrative cross-sectional view of a camera lens in accordance with a third exemplary embodiment of the present invention.

FIG. 6 is an exploded view of the camera lens in FIG. 5.

FIG. 7 is an illustrative cross-sectional view of a camera lens in accordance with a fourth exemplary embodiment of the present invention.

FIG. 8 is an illustrative cross-sectional view of a camera lens in accordance with a fifth exemplary embodiment of the present invention, showing a first form of an engagement of a first holder and a second holder.

FIG. 9 is an exploded view of the camera lens in FIG. 8.

FIG. 10 is an illustrative cross-sectional view of the camera lens in accordance with the fifth exemplary embodiment, showing a second form of the engagement of the first holder and the second holder.

FIG. 11 is an illustrative cross-sectional view of the camera lens in accordance with the fifth exemplary embodiment, showing a third form of the engagement of the first holder and the second holder.

FIG. 12 is an illustrative cross-sectional view of the camera lens in accordance with the fifth exemplary embodiment, showing a fourth form of the engagement of the first holder and the second holder.

FIG. 13 is an illustrative cross-sectional view of a camera lens in accordance with a sixth exemplary embodiment of the present invention, showing a first form of an engagement of a first holder and a second holder.

FIG. 14 is an illustrative cross-sectional view of the camera lens in accordance with the sixth exemplary embodiment, showing a second form of the engagement of the first holder and the second holder.

FIG. 15 is an illustrative cross-sectional view of the camera lens in accordance with the sixth exemplary embodiment, showing a third form of the engagement of the first holder and the second holder.

FIG. 16 is an illustrative cross-sectional view of the camera lens in accordance with the sixth exemplary embodiment, showing a fourth form of the engagement of the first holder and the second holder.

FIG. 17 is an illustrative cross-sectional view of a camera lens in accordance with a seventh exemplary embodiment of the present invention, showing a first form of an engagement of a first holder and a second holder.

FIG. 18 is an exploded view of the camera lens in FIG. 17.

FIG. 19 is an illustrative cross-sectional view of the camera lens in accordance with the seventh exemplary embodiment, showing a second form of the engagement of the first holder and the second holder.

FIG. 20 is an illustrative cross-sectional view of the camera lens in accordance with the seventh exemplary embodiment, showing a third form of the engagement of the first holder and the second holder.

FIG. 21 is an illustrative cross-sectional view of the camera lens in accordance with the seventh exemplary embodiment, showing a fourth form of the engagement of the first holder and the second holder.

FIG. 22 is an illustrative cross-sectional view of a camera lens in accordance with an eighth exemplary embodiment of the present invention.

### DETAILED DESCRIPTION OF THE EXEMPLARY EMBODIMENTS

The present disclosure will hereinafter be described in detail with reference to several exemplary embodiments. To make the technical problems to be solved, technical solutions and beneficial effects of the present disclosure more apparent, the present disclosure is described in further detail together with the figure and the embodiments. It should be understood the specific embodiments described hereby are only to explain the disclosure, not intended to limit the disclosure.

A camera lens in accordance with an embodiment of the present invention includes a lens holder and a lens group accommodated in the lens holder. The lens group includes a first lens unit. The lens holder includes a first holder and a second holder covering the first lens holder and having a light aperture. The first and second holders form an accommodation space for receiving the first lens unit therein. The first lens unit includes an object side surface adjacent to the light aperture, and the first holder or the second holder abuts against the object side surface of the first lens unit. The first holder includes a first complementary configuration, and the second holder includes a second complementary configuration for engaging with the first complementary configuration. The first complementary configuration is engaged with the second complementary configuration by buckles or by screws/threads. In case of buckles, the first complementary configuration serves as a first buckle, and the second complementary configuration serves as a second buckle. In case of threads, the first complementary configuration serves as a first thread portion, and the second complementary configuration serves as a second thread portion. In the first, second, third, and four embodiments, the second holder abuts against the object side surface of the first lens unit; in the fifth, sixth, seventh, and eighth embodiments, the first holder abuts against the object side surface of the first lens unit.

### First Embodiment

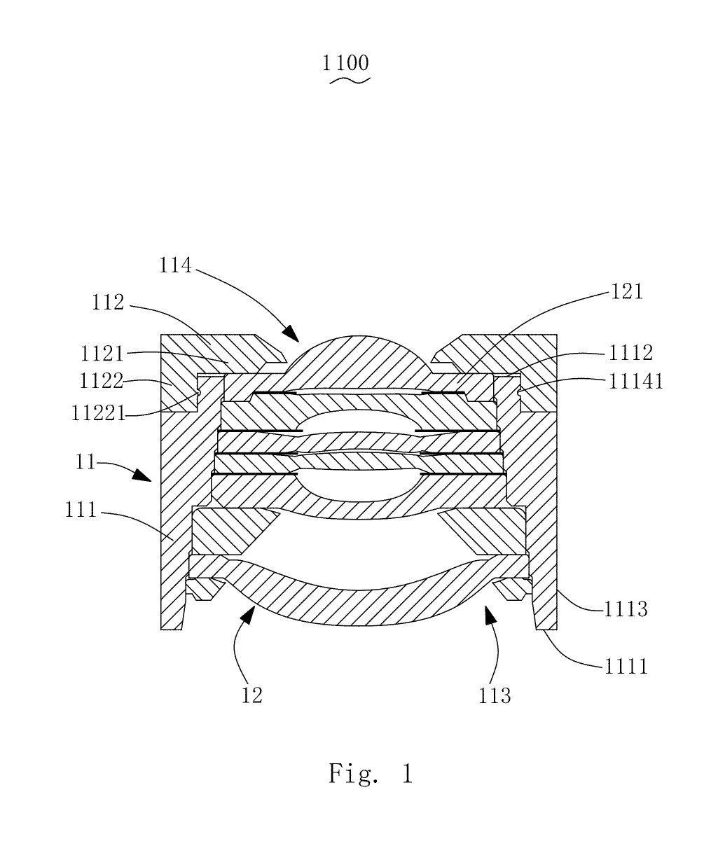

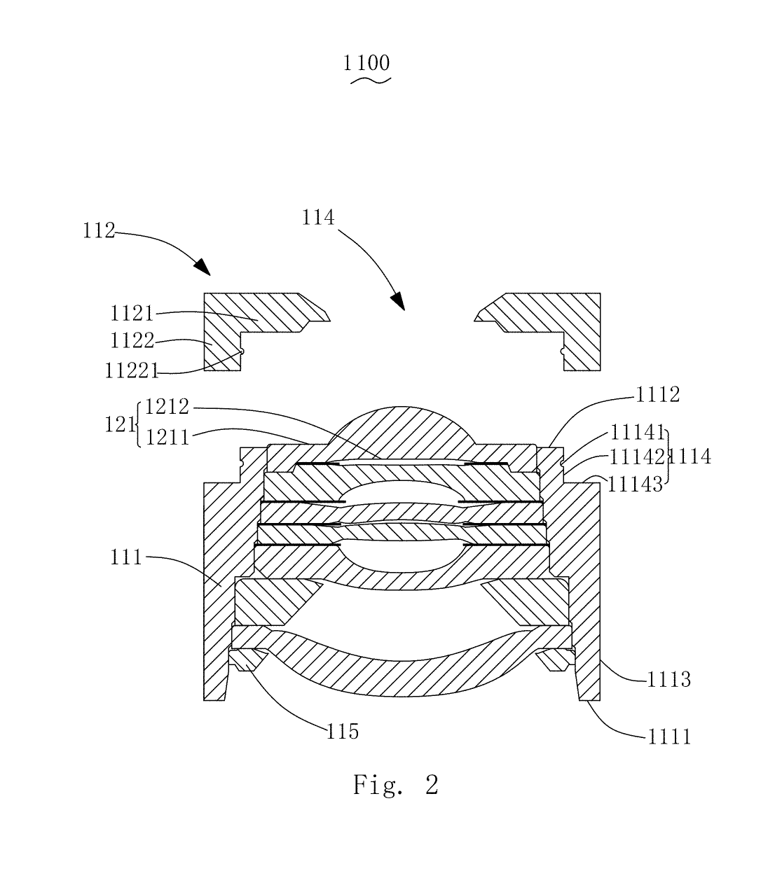

Referring to FIGS. 1-2, a camera lens 1100 includes a lens holder 11 and a lens group 12 accommodated in the lens holder 11.

The lens holder 11 includes a first holder 111 and a second holder 112 covering and engaging with the first holder 111. The second holder 112 forms a light aperture 114 penetrating therethrough. The first holder 111 and the second holder 112 cooperatively form an accommodation space 113. The lens group 12 accommodates in the accommodation space 113. The lens group 12 includes an object side surface adjacent to the light aperture 114, and the second holder 112 abuts against the object side surface of the lens group 12. The first holder 111 includes a first complementary configuration 11141, and the second holder 112 includes a second complementary configuration 11221 for engaging with the first complementary configuration 11141. Thereby, the lens holder 11 is configured to be a two-piece structure, which makes it convenient and high efficient to assemble the camera lens.

In the embodiment, the first complementary configuration 11141 is a ring-shaped slot, and the second complementary configuration 11221 is a protrusion engaging with the ring-shaped slot; or, the first complementary configuration 11141 is a protrusion, and the second complementary configuration 11221 is a ring-shaped slot engaging with the protrusion.

The lens group 12 is located in the accommodation space 113. The lens group 12 is configured to be concentric with the light aperture 114. In the embodiment, the lens group 12 includes at least a first lens unit 121 adjacent to the second holder 112.

The first holder 111 includes a bottom surface 1111, a top surface 1112 opposite to the bottom surface 1111, and a side surface 1113 connecting the bottom surface 1111 and the top surface 1112. Further, from the top surface 1112 toward the bottom surface 1111, a recess 1114 (referring to FIG. 2) is formed and a first buckle 11141 is formed in the recess 1114.

The second holder 112 includes a main side 1121 and an auxiliary side 1122 extending perpendicularly from the main side 1121. The light aperture 114 is formed in the main side 1121. The auxiliary side 1122 includes a second buckle 11221 engaging with the first buckle 11141. The second holder 112 covers the top surface 1112 of the first holder 111 and positions the auxiliary side 1122 in the recess 1114 by virtue of the engagement of the first buckle 11141 and the second buckle 11221, which assembles the first holder 111 with the second holder 112. By the two-piece structure, the first and second holders 111, 112 can made from different materials. For example, the second holder 112 can be made from materials with high light absorptivity for reducing stray light and further for improving optical performance.

In the embodiment, the first buckle 11141 is ring-shaped, and the accordingly, the second buckle 11221 is also ring-shaped. A cross-sectional view of the first buckle or the second buckle is substantially semicircle, trapezoid, or rectangular. The recess 1114 is formed by a first wall 11142 connecting with the top surface 1112, a second wall 11143 extending from the first wall perpendicularly. The second wall 11143 connects with the side surface 1113. In FIG. 2, the first wall 11142 is a vertical wall, and the second wall 11143 is a horizontal wall.

The first buckle 11141 is formed on the first wall 11142, and the second buckle 11221 is formed on a side of the second holder adjacent to the first wall 11142. A direction of the engagement between the first buckle and second buckle is parallel to the second wall 11143. The auxiliary wall 1122 can keep a distance from the second wall 11143, or abut against the second wall 11143.

The first lens unit 121 includes an object side surface 1211 adjacent to the light aperture 114 and an image side surface 1212 opposite to the object side surface 1211. The first lens unit 121 is positioned by the first holder 111 and the object side surface of the first lens unit 121 is nearer the main wall 1121 of the second holder than the top surface 1112 of the first holder 111. The main wall 1121 abuts against the object side surface 1211 of the first lens unit 121, and keeps a distance from the top surface 1112 of the first holder 111. By virtue of such a configuration, the first holder 111 can be easier removed from or assembled with the second holder 112. And, because the second holder 112 can be removed from the first holder 111, the second holder can be replaced by another second holder 112 with a bigger light aperture, according to different requirements. In addition, the main wall 1121 abuts against the object side surface 1211 of the first lens unit 121 for serving as a pressing ring for positioning the first lens unit 121 on the first holder 111.

The camera lens 1100 further includes a pressing ring 115 located on the image side surface of the first lens unit.

### Second Embodiment

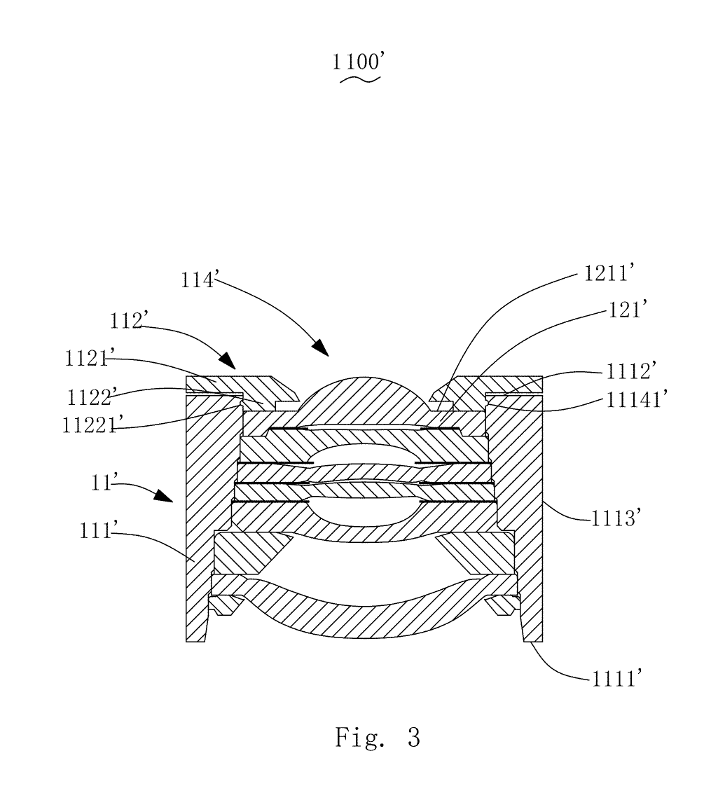

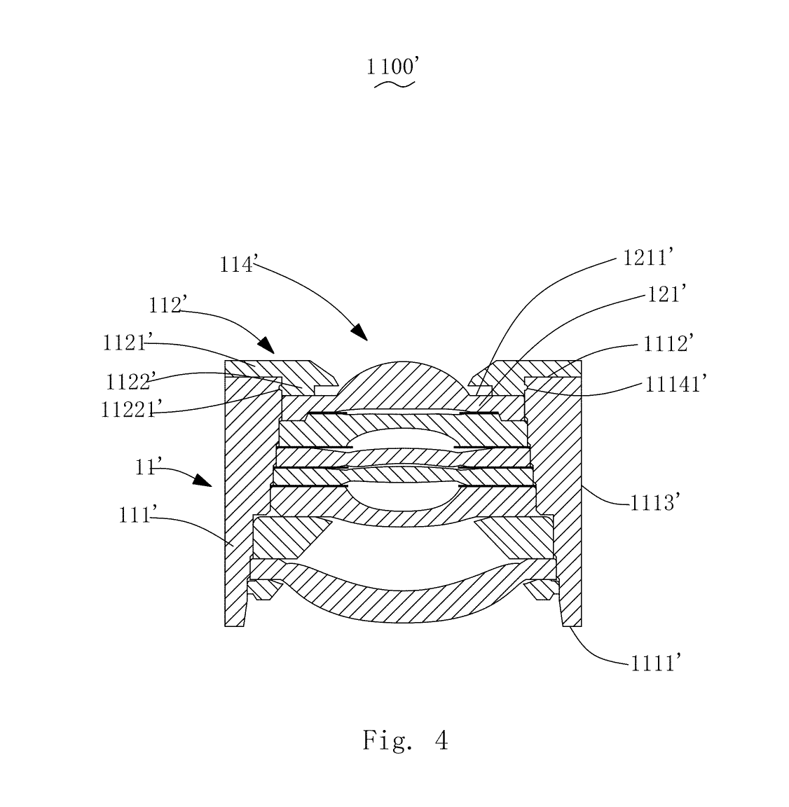

Referring to FIGS. 3-4, the first holder 111′ of the lens holder 11′ includes a bottom surface 1111′, a top surface 1112′ opposite to the bottom surface 1111′, and a side surface 1113′ adjacent to the accommodation space for connecting the top surface 1112′ to the bottom surface 1112′. The first buckle 11141′ is formed on the side surface 1113′ near the accommodation space.

The second holder 112′ includes a main wall 1121′ with a light aperture 114′ and an auxiliary wall 1122′ extending perpendicularly from the main wall 1121′. The main wall 1121′ covers the top surface 1111′ of the first holder 111′. The auxiliary wall 1122′ abuts against the side surface 1113′ adjacent to the accommodation space, and the second buckle 11221′ is formed on the auxiliary wall 1122′. Therefore, the second embodiment discloses another form of the configuration of the first buckle and the second buckle. Other configurations not mentioned in this embodiment are similar to what have been disclosed in the first embodiment.

### Third Embodiment

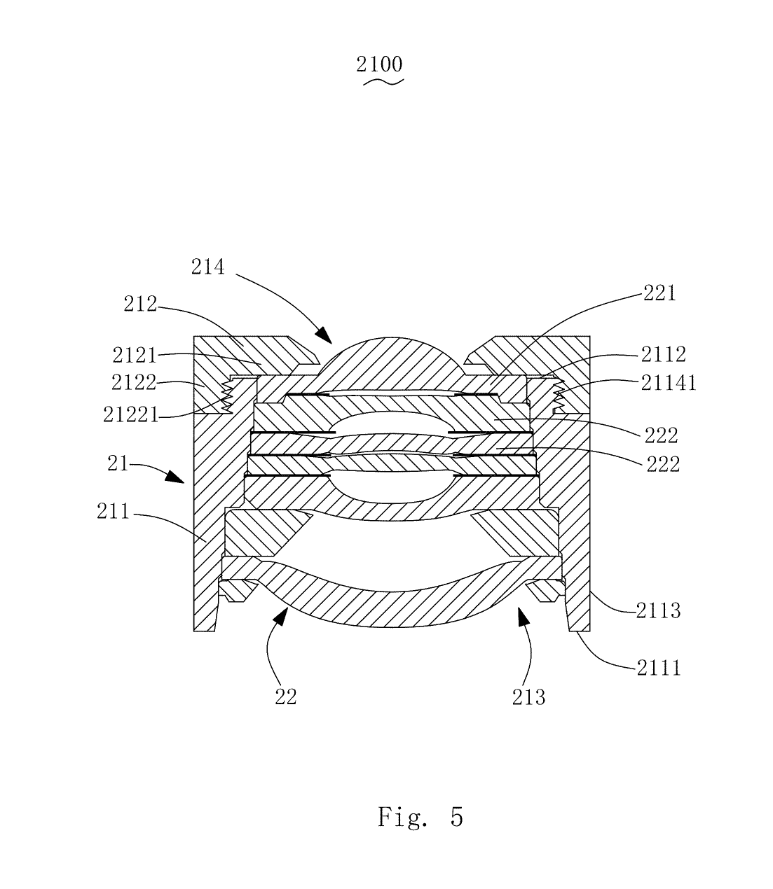

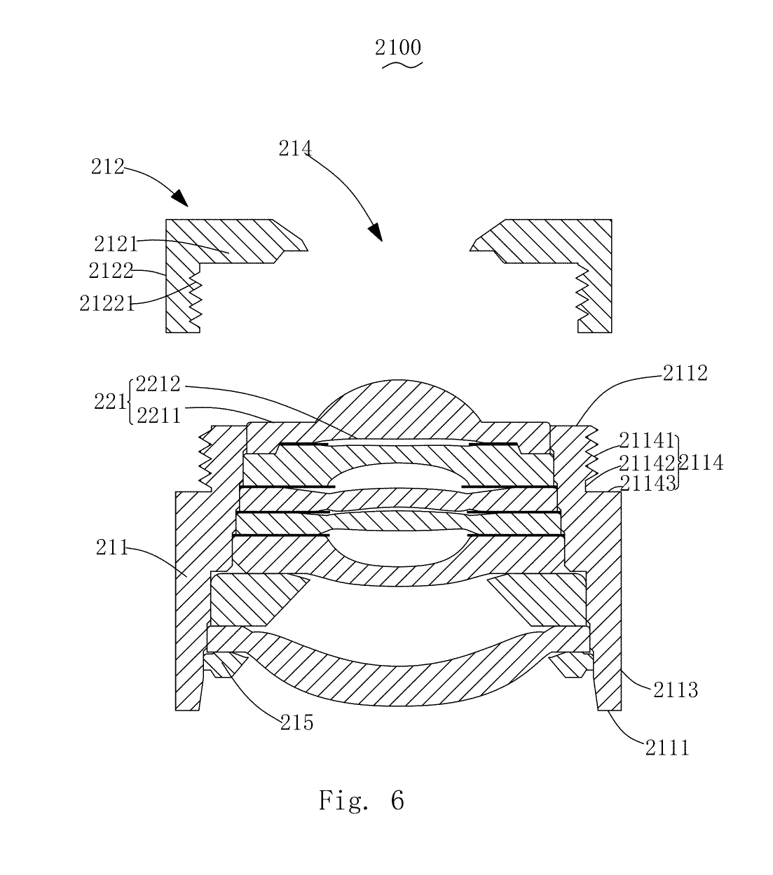

Referring to FIGS. 5-6, a camera lens 2100 includes a lens holder 21 and a lens group 22 positioned in the lens holder 21. The lens holder 21 includes a first holder 211 and a second holder 212 covering the first holder 21 for forming an accommodation space 213. The second holder 212 is formed with a light aperture 214. The lens group 22 is received in the accommodation space 213 and includes an object side surface adjacent to the light aperture 214. The second holder 212 abuts against the object side surface of the lens group 22. The first holder 211 includes a first thread portion 21141, and correspondingly the second holder 212 includes a second thread portion 21221 engaging with the first thread portion 21141. By the two-piece structure, the first and second holders 211, 212 can made from different materials. For example, the second holder 1212 can be made from materials with high light absorptivity for reducing stray light and further for improving optical performance.

The lens group 22 is received in the accommodation space, and is concentric with the light aperture. In this embodiment, the lens group 22 includes a first lens unit 221 adjacent to the light aperture of the second holder 212 and a second lens unit 222 stacked on the first lens unit 221.

The first holder 211 includes a bottom surface 2111, a top surface 2112 opposite to the bottom surface 2111, and a side surface 2113 connecting the top surface 2112 to the bottom surface 2111. A recess 2114 is formed by recessing from the top surface 2111 toward the bottom surface 2112. The first thread portion 21141 is formed on the side surface 2113 in the recess 2114. In the embodiment, the first thread portion 21141 is provided with an external thread.

The second holder 212 includes a main wall 2121 and an auxiliary wall 2122 extending perpendicularly from the main wall 2121. A light aperture 214 is formed in the main wall 2121. The auxiliary wall 2122 is provided with a second thread portion 21221 having an internal thread. The second holder 212 covers the top surface 2112 of the first holder 211 and the auxiliary wall 2122 is at least partially received in the recess 2114. The first thread portion and the second thread portion 21141, 21221 engage with each other for assembling the first holder 211 with the second holder 212.

Specifically, the recess 2114 is formed by a first wall 21142 connecting the top surface 21142, and a second wall 21143 connecting the side surface 2113. As shown in FIG. 5, the first wall 21142 is a parallel wall and the second wall 21143 is a horizontal wall. The first thread portion 21141 is formed on the first wall 21142, and the second thread portion 21221 is formed on a side of the second holder adjacent to the first wall 21142. A direction of the engagement between the first thread and second thread is parallel to the second wall 21143. The auxiliary wall 2122 can keep a distance from the second wall 21143, or abut against the second wall 21143.

The first lens unit 221 includes an object side surface 2211 adjacent to the light aperture 214 and an image side surface 2212 opposite to the object side surface 2211. The first lens unit 221 is positioned by the first holder 211 and the object side surface of the first lens unit 221 is nearer the main wall 2121 of the second holder than the top surface 2112 of the first holder 211. The main wall 2121 abuts against the object side surface 2211 of the first lens unit 221, and keeps a distance from the top surface 2112 of the first holder 211. By virtue of such a configuration, the first holder 211 can be easier removed from or assembled with the second holder 212. And, because the second holder 212 can be removed from the first holder 211, the second holder can be replaced by another second holder 212 with a bigger light aperture, according to different requirements. In addition, the main wall 2121 abuts against the object side surface 2211 of the first lens unit 221 for serving as a pressing ring for positioning the first lens unit 221 on the first holder 211. The camera lens 2100 further includes a pressing ring 215 located on the image side surface of the first lens unit.

### Fourth Embodiment

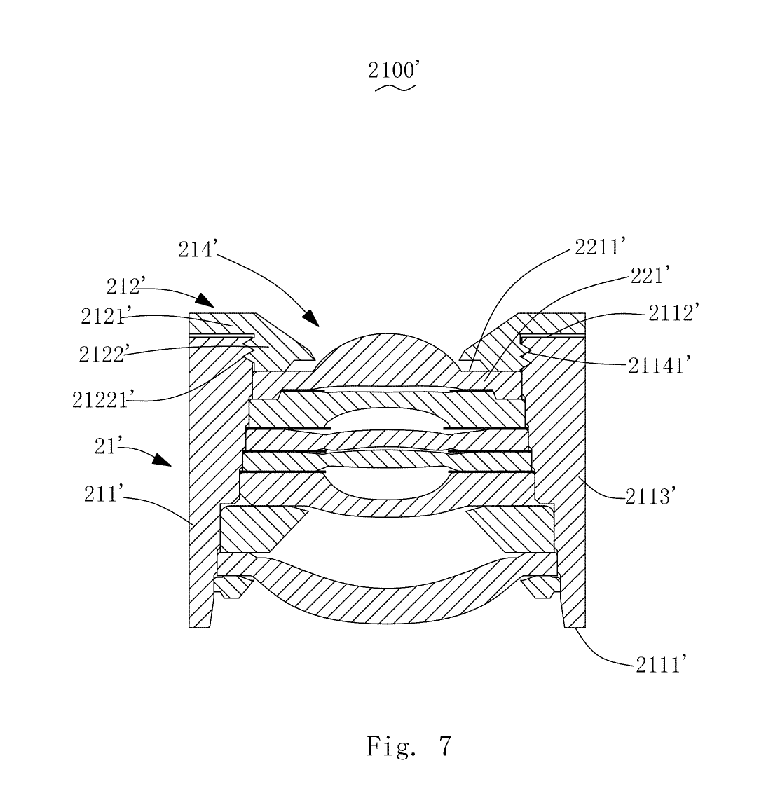

Referring to FIG. 7, the first holder 11′ of the lens holder 1′ includes a bottom surface 111′, a top surface 112′ opposite to the bottom surface 111′, and a side surface 113′ adjacent to the accommodation space for connecting the top surface 112′ to the bottom surface 112′. The first thread portion 1141′ is formed on the side surface 113′ near the accommodation space. The first thread portion 1141′ here is provided with an internal thread.

The second holder 12′ includes a main wall 121′ with a light aperture 14′ and an auxiliary wall 122′ extending perpendicularly from the main wall 121′. The main wall 121′ covers the top surface 111′ of the first holder 11′. The auxiliary wall 122′ abuts against the side surface 113′ adjacent to the accommodation space, and the second thread portion 1221′ is formed on the auxiliary wall 122′. The second thread portion 1221′ here is provided with an external thread. Therefore, the second embodiment discloses another form of the configuration of the first thread portion and the second thread portion. Other configurations not mentioned in this embodiment are similar to what have been disclosed in the first embodiment.

### Fifth Embodiment

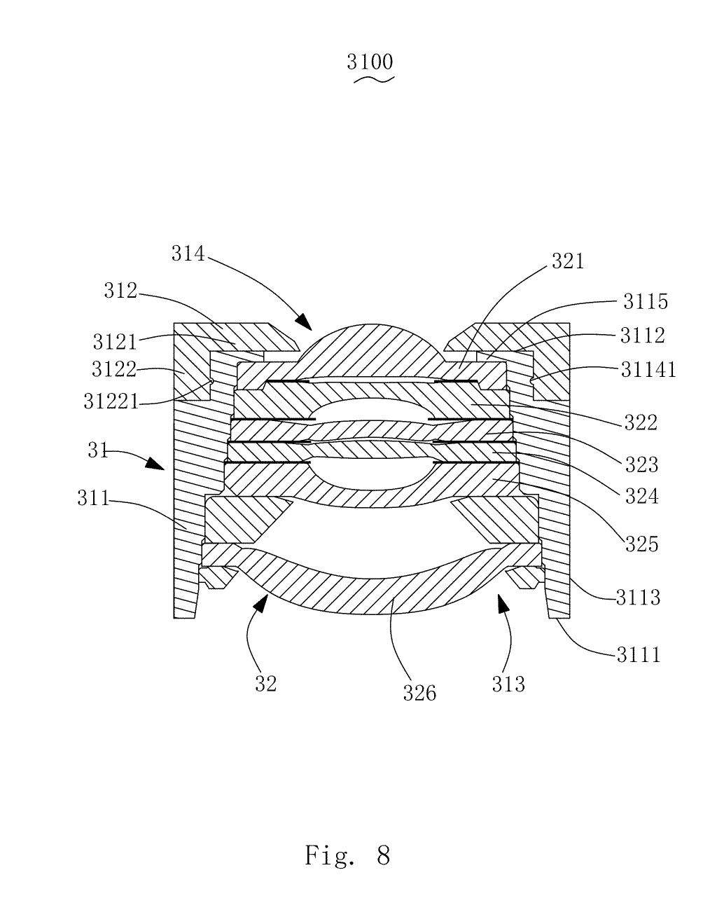

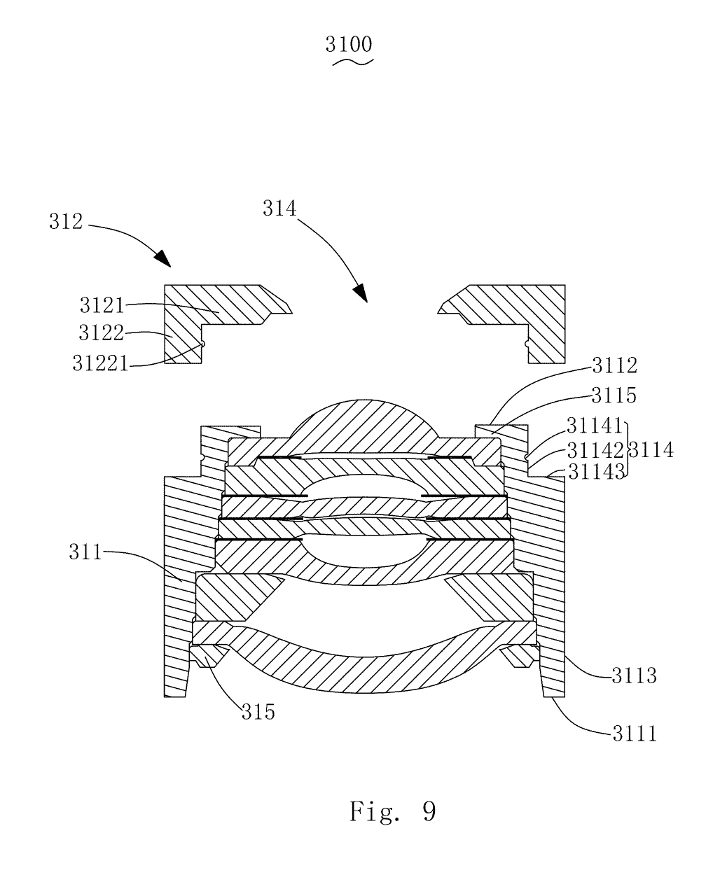

Referring to FIGS. 8-9, a camera lens 3100 includes a lens holder 31 and a lens group 32 accommodated in the lens holder 31.

The lens holder 31 includes a first holder 311 and a second holder 312 covering and engaging with the first holder 311. The second holder 312 forms a light aperture 314 penetrating therethrough. The first holder 311 and the second holder 312 cooperatively form an accommodation space 313. The lens group 32 accommodates in the accommodation space 313. The lens group 32 includes an object side surface adjacent to the light aperture 314, and the first holder 311 abuts against the object side surface of the lens group 32. The first holder 311 includes a first complementary configuration 31141, and the second holder 312 includes a second complementary configuration 31221 for engaging with the first complementary configuration 31141. Thereby, the lens holder 31 is configured to be a two-piece structure, which makes it convenient and high efficient to assemble the camera lens.

In the embodiment, the first complementary configuration 31141 is a ring-shaped slot, and the second complementary configuration 31221 is a protrusion engaging with the ring-shaped slot; or, the first complementary configuration 31141 is a protrusion, and the second complementary configuration 31221 is a ring-shaped slot engaging with the protrusion.

The lens group 32 is located in the accommodation space 313. The lens group 32 is configured to be concentric with the light aperture 314. In the embodiment, the lens group 32 includes at least a first lens unit 321 adjacent to the second holder 312.

The first holder 311 includes a bottom surface 3111, a top surface 3112 opposite to the bottom surface 3111, and a side surface 3113 connecting the bottom surface 3111 and the top surface 3112. Further, from the top surface 3112 toward the bottom surface 3111, a recess 3114 (referring to FIG. 9) is formed and a first buckle 31141 is formed in the recess 3114. The first holder 311 further includes a pressing wall 3115 extending from the top surface 3112 toward a central axis of the first holder 311. The pressing wall 3115 abuts against the first lens unit 321.

The second holder 312 includes a main side 3121 and an auxiliary side 3122 extending perpendicularly from the main side 3121. The light aperture 314 is formed in the main side 3121. The auxiliary side 1122 includes a second buckle 31221 engaging with the first buckle 31141. The second holder 312 covers the top surface 3112 of the first holder 311 and positions the auxiliary side 3122 in the recess 3114 by virtue of the engagement of the first buckle 31141 and the second buckle 31221, which assembles the first holder 111 with the second holder 112. By the two-piece structure, the first and second holders 111, 112 can made from different materials. For example, the second holder 112 can be made from materials with high light absorptivity for reducing stray light and further for improving optical performance.

In the camera lens 3100, the lens unit 32 includes a first lens unit 321, a second lens unit 322, a third lens unit 323, a fourth lens unit 324, a fifth lens unit 325, and a sixth lens unit 326. The pressing wall 3115 presses on the first lens unit for serving as a pressing ring to position the lens group.

In the embodiment, the first buckle 31141 is ring-shaped, and the accordingly, the second buckle 31221 is also ring-shaped. A cross-sectional view of the first buckle or the second buckle is substantially semicircle, trapezoid, or rectangular. The recess 3114 is formed by a first wall 31142 connecting with the top surface 3112, a second wall 31143 extending from the first wall perpendicularly. The second wall 31143 connects with the side surface 3113. In FIG. 9, the first wall 31142 is a vertical wall, and the second wall 31143 is a horizontal wall.

The first buckle 31141 is formed on the first wall 31142, and the second buckle 31221 is formed on a side of the second holder adjacent to the first wall 31142. A direction of the engagement between the first buckle and second buckle is parallel to the second wall 31143. The auxiliary wall 3122 can keep a distance from the second wall 31143, or abut against the second wall 31143.

In this embodiment, four forms, as shown in FIGS. 8, 10, 11, and 12, are presented to indicate the engagement between the first holder 311 and the second holder 312.

Form 1

As shown in FIG. 8, the main side 3121 of the second holder 312 abuts against the pressing wall 3115 of the first holder 311, and the auxiliary side 3122 of the second holder 312 abuts against the second wall 31143 of the recess 3114.

Form 2

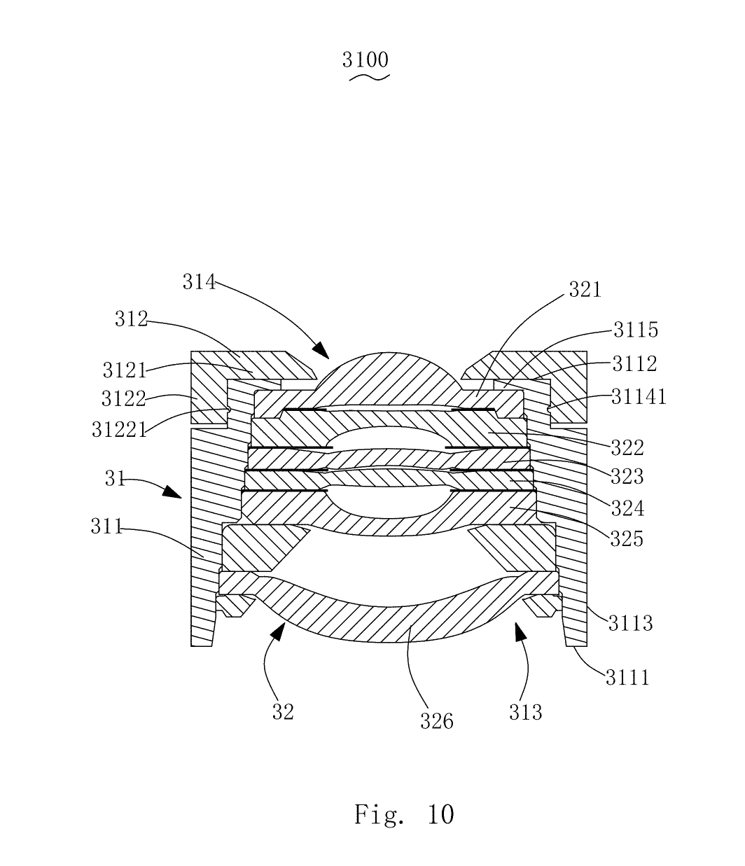

As shown in FIG. 10, the main side 3121 of the second holder 312 abuts against the pressing wall 3115 of the first holder 311, and the auxiliary side 3122 of the second holder 312 keeps a distance from the second wall 31143 of the recess 3114.

Form 3

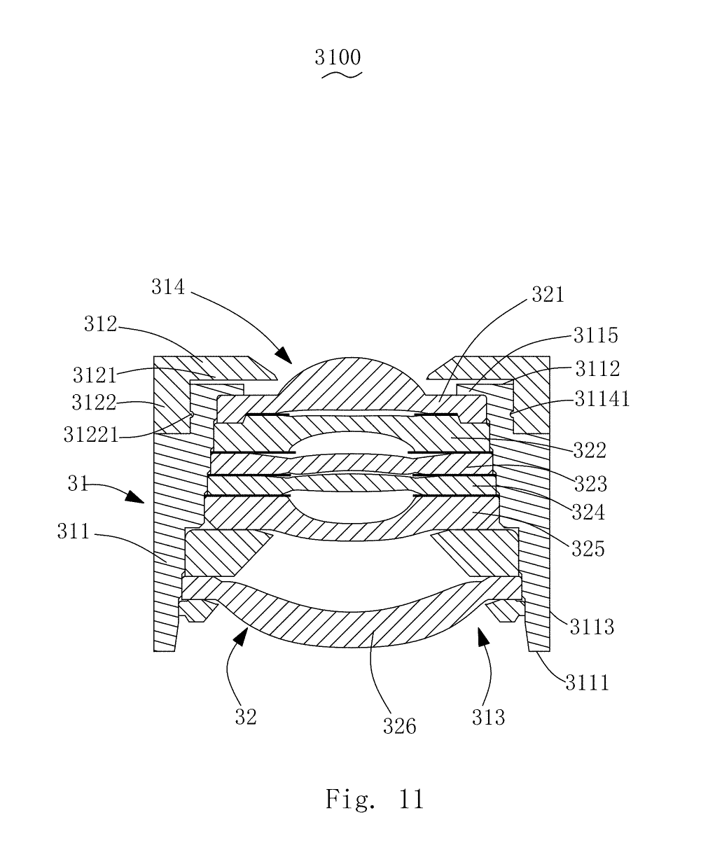

As shown in FIG. 11, the main side 3121 of the second holder 312 covers and keeps a distance from the pressing wall 3115 of the first holder 311, and the auxiliary side 3122 of the second holder 312 abuts against the second wall 31143 of the recess 3114.

Form 4

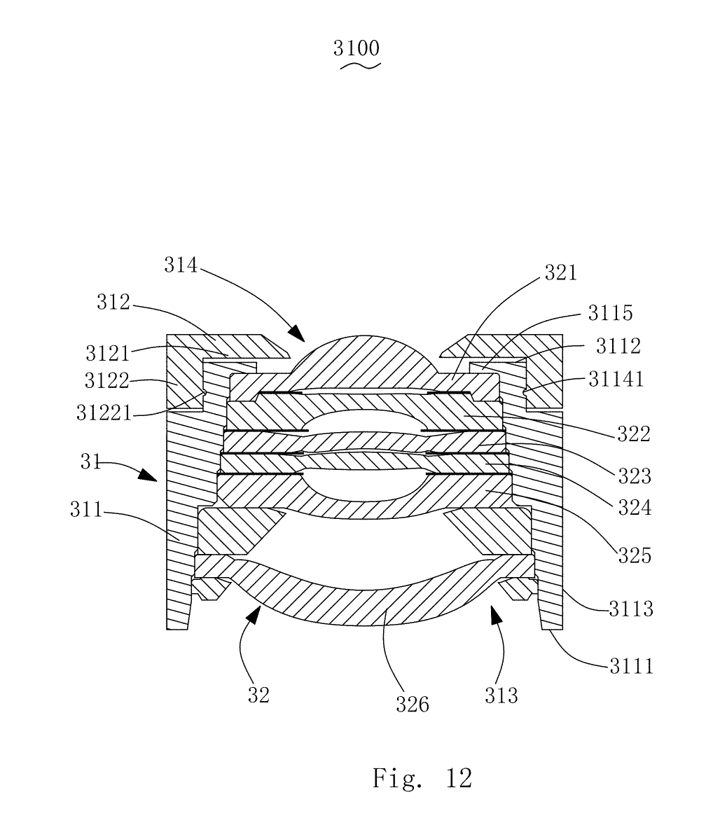

As shown in FIG. 12, the main side 3121 of the second holder 312 covers and keeps a distance from the pressing wall 3115 of the first holder 311, and the auxiliary side 3122 of the second holder 312 keeps a distance from the second wall 31143 of the recess 3114.

The camera lens 3100 further includes a pressing ring 315 located on the image side surface of the first lens unit.

### Sixth Embodiment

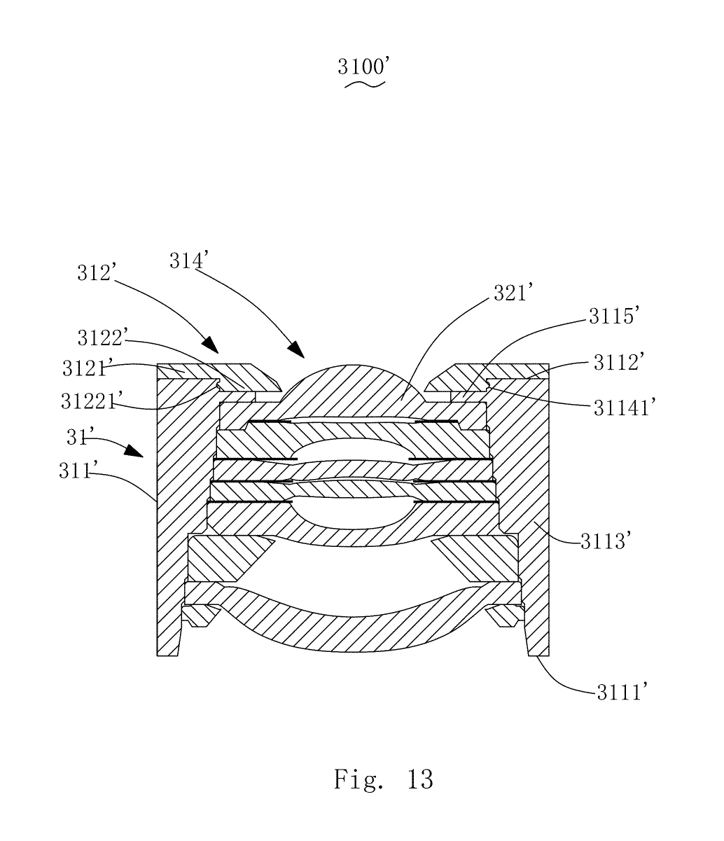

Referring to FIG. 13, the first holder 311′ of the lens holder 31′ includes a bottom surface 3111′, a top surface 3112′ opposite to the bottom surface 3111′, a side surface 3113′ adjacent to the accommodation space for connecting the top surface 3112′ to the bottom surface 3112′, and a pressing wall 3115′ extending from the side surface 3113′ for pressing on the first lens unit 321′. The first buckle 31141′ is formed on the side surface 3113′ near the accommodation space.

The second holder 312′ includes a main wall 3121′ with a light aperture 314′ and an auxiliary wall 3122′ extending perpendicularly from the main wall 3121′. The main wall 3121′ covers the top surface 3111′ of the first holder 311′. The auxiliary wall 3122′ abuts against the side surface 3113′ adjacent to the accommodation space, and the second buckle 31221′ is formed on the auxiliary wall 3122′.

In this embodiment, four forms, as shown in FIGS. 13-16, are presented to indicate the engagement between the first holder 311′ and the second holder 312′.

Form 1

As shown in FIG. 13, the auxiliary wall 3122′ of the second holder 312′ abuts against the pressing wall 3115′ of the first holder 311′. At the same time, the main wall 3121′ of the second holder 312′ abuts against the top surface 3112′ of the first holder 311′.

Form 2

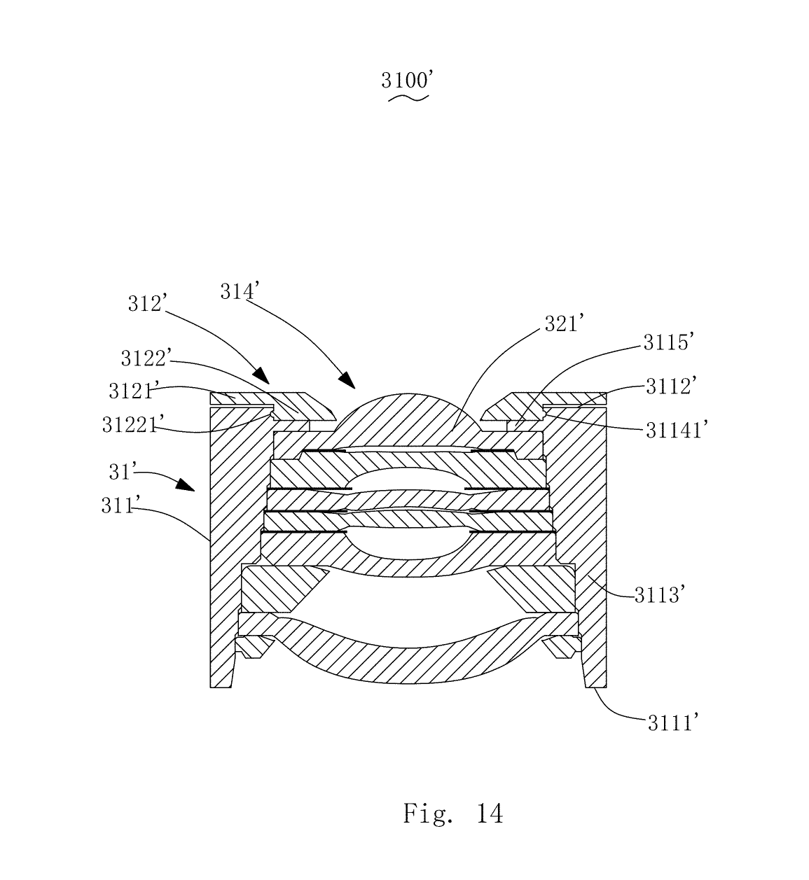

As shown in FIG. 14, the auxiliary wall 3122′ of the second holder 312′ abuts against the pressing wall 3115′ of the first holder 311′. At the same time, the main wall 3121′ of the second holder 312′ keeps a distance from the top surface 3112′ of the first holder 311′.

Form 3

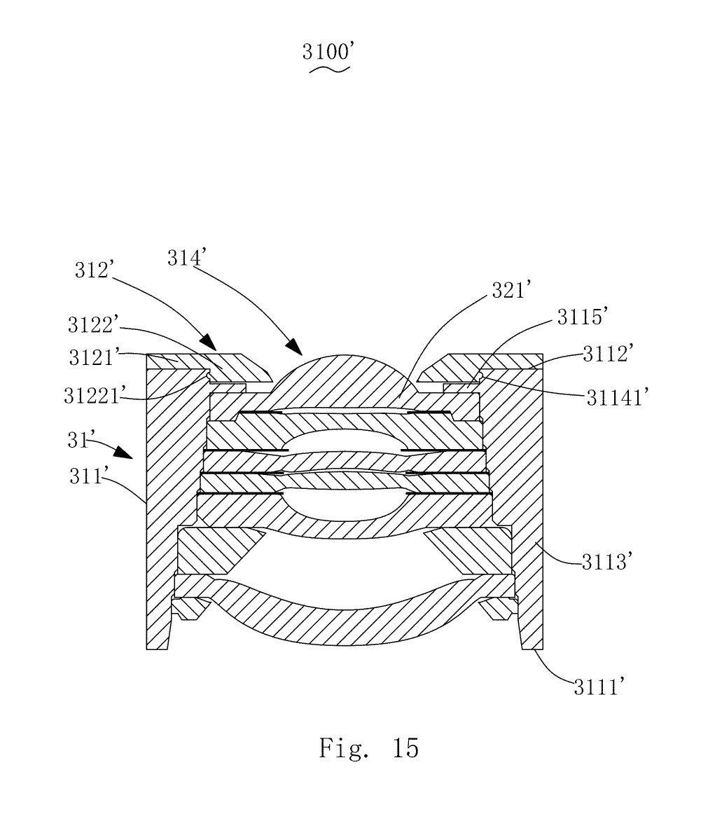

As shown in FIG. 15, the auxiliary wall 3122′ of the second holder 312′ keeps a distance from the pressing wall 3115′ of the first holder 311′. At the same time, the main wall 3121′ of the second holder 312′ abuts against the top surface 3112′ of the first holder 311′.

Form 4

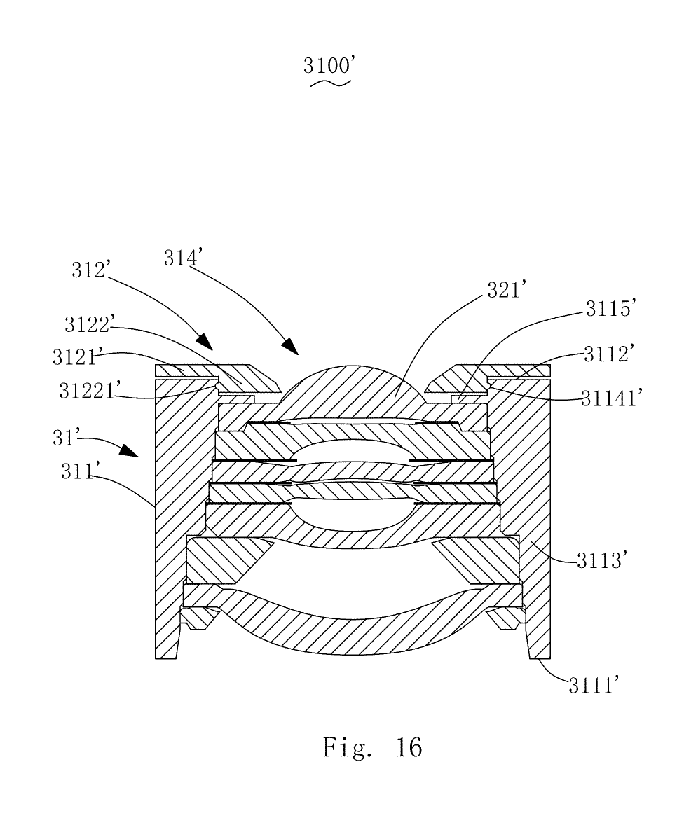

As shown in FIG. 16, the auxiliary wall 3122′ of the second holder 312′ keeps a distance from the pressing wall 3115′ of the first holder 311′. At the same time, the main wall 3121′ of the second holder 312′ keeps a distance from the top surface 3112′ of the first holder 311′.

### Seventh Embodiment

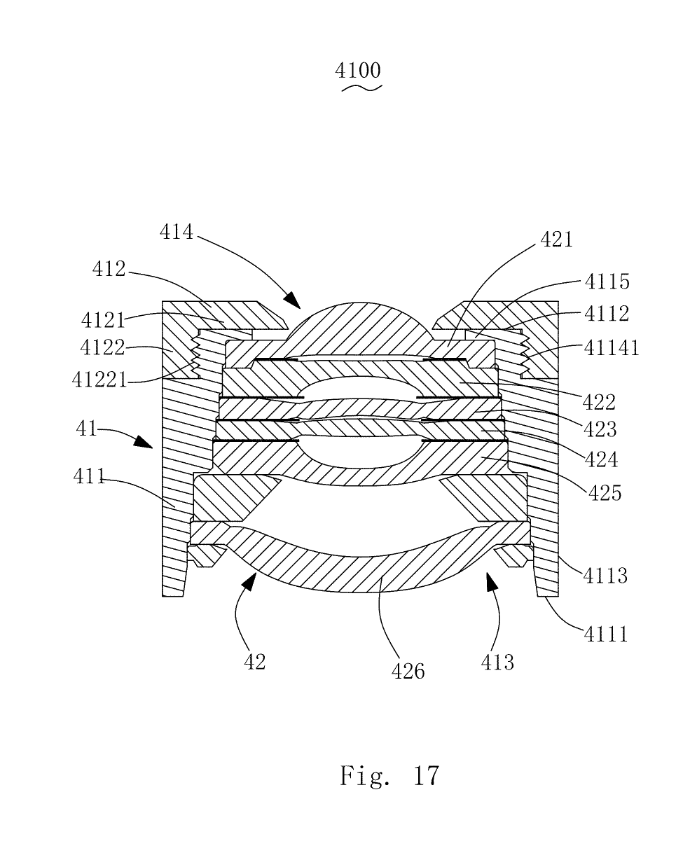

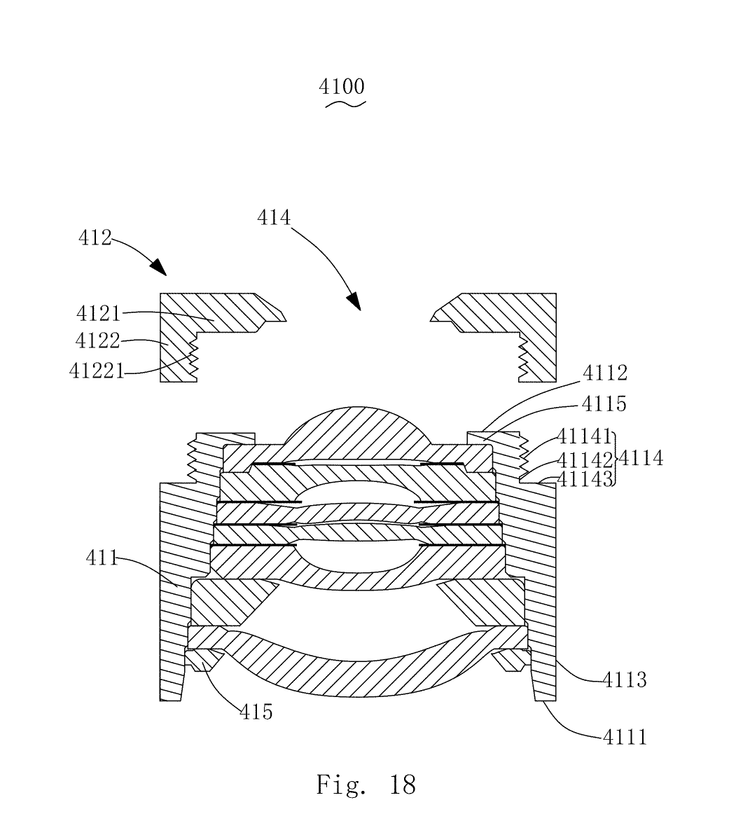

Referring to FIGS. 17-21, a camera lens 4100 includes a lens holder 41 and a lens group 42 positioned in the lens holder 41. The lens holder 41 includes a first holder 411 and a second holder 412 covering the first holder 41 for forming an accommodation space 413. The second holder 412 is formed with a light aperture 414. The lens group 42 is received in the accommodation space 413 and includes an object side surface adjacent to the light aperture 414. The first holder 411 abuts against the object side surface of the lens group 42. The first holder 411 includes a first thread portion 41141, and correspondingly the second holder 412 includes a second thread portion 41221 engaging with the first thread portion 41141. By the two-piece structure, the first and second holders 411, 412 can made from different materials. For example, the second holder 4212 can be made from materials with high light absorptivity for reducing stray light and further for improving optical performance.

The lens group 42 is received in the accommodation space, and is concentric with the light aperture. In this embodiment, the lens group 42 includes a first lens unit 421 adjacent to the light aperture of the second holder 412 and a second lens unit 422 stacked on the first lens unit 221. Further, the lens group 42 includes a third lens unit 423, a fourth lens unit 424, a fifth lens unit 425, and a sixth lens unit 426.

The first holder 411 includes a bottom surface 4111, a top surface 4112 opposite to the bottom surface 4111, a side surface 4113 connecting the top surface 4112 to the bottom surface 4111, and a pressing wall 4115 pressing on the first lens unit 421. A recess 4114 is formed by recessing from the top surface 4111 toward the bottom surface 4112. The first thread portion 41141 is formed on the side surface 4113 in the recess 4114. In the embodiment, the first thread portion 41141 is provided with an external thread.

The second holder 412 includes a main wall 4121 and an auxiliary wall 4122 extending perpendicularly from the main wall 4121. A light aperture 414 is formed in the main wall 4121. The auxiliary wall 4122 is provided with a second thread portion 41221 having an internal thread. The second holder 412 covers the top surface 4112 of the first holder 411 and the auxiliary wall 4122 is at least partially received in the recess 4114. The first thread portion and the second thread portion 41141, 41221 engage with each other for assembling the first holder 411 with the second holder 412.

Specifically, the recess 4114 is formed by a first wall 41142 connecting the top surface 41142, and a second wall 41143 connecting the side surface 4113. The first wall 41142 is a parallel wall and the second wall 41143 is a horizontal wall. The first thread portion 41141 is formed on the first wall 41142, and the second thread portion 41221 is formed on a side of the second holder adjacent to the first wall 41142. A direction of the engagement between the first thread and second thread is parallel to the second wall 41143. The auxiliary wall 4122 can keep a distance from the second wall 41143, or abut against the second wall 41143.

By virtue of such a configuration, the first holder 411 can be easier removed from or assembled with the second holder 412. And, because the second holder 412 can be removed from the first holder 411, the second holder can be replaced by another second holder 412 with a bigger light aperture, according to different requirements. In addition, the pressing wall 4115 abuts against the object side surface of the first lens unit 421 for serving as a pressing ring for positioning the first lens unit 421 on the first holder 411. The camera lens 4100 further includes a pressing ring 415 located on the image side surface of the first lens unit.

In this embodiment, four forms, as shown in FIGS. 17, 19-21, are presented to indicate the engagement between the first holder 411 and the second holder 412.

Form 1

As shown in FIG. 17, the main wall 4121 of the second holder 412 abuts against the pressing wall 4115 of the first holder 411, while, the auxiliary wall 4122 of the second holder 412 abuts against the second wall 41143 of the recess 4114.

Form 2

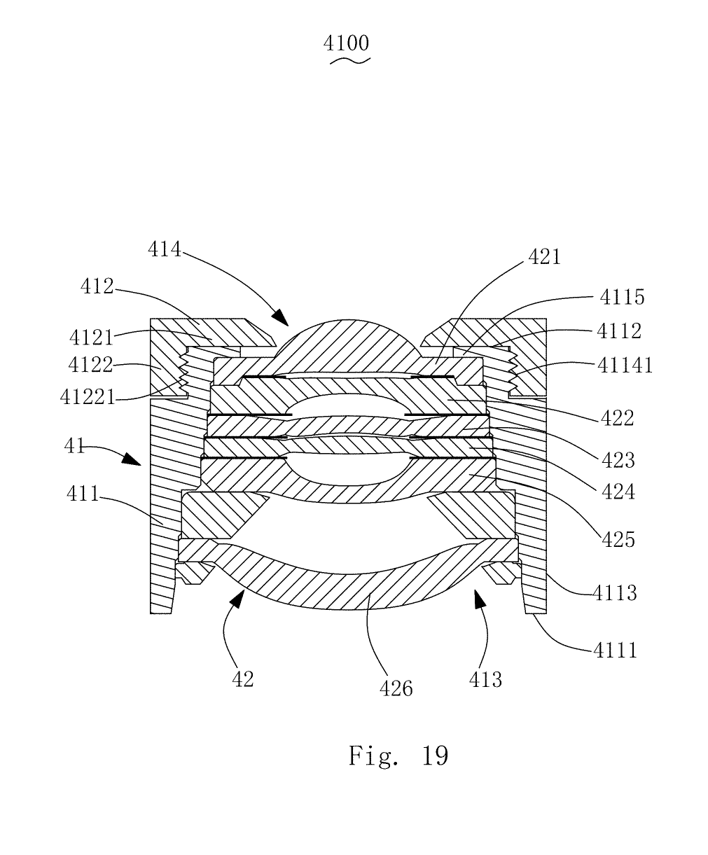

As shown in FIG. 19, the main wall 4121 of the second holder 412 abuts against the pressing wall 4115 of the first holder 411, while, the auxiliary wall 4122 of the second holder 412 keeps a distance from the second wall 41143 of the recess 4114.

Form 3

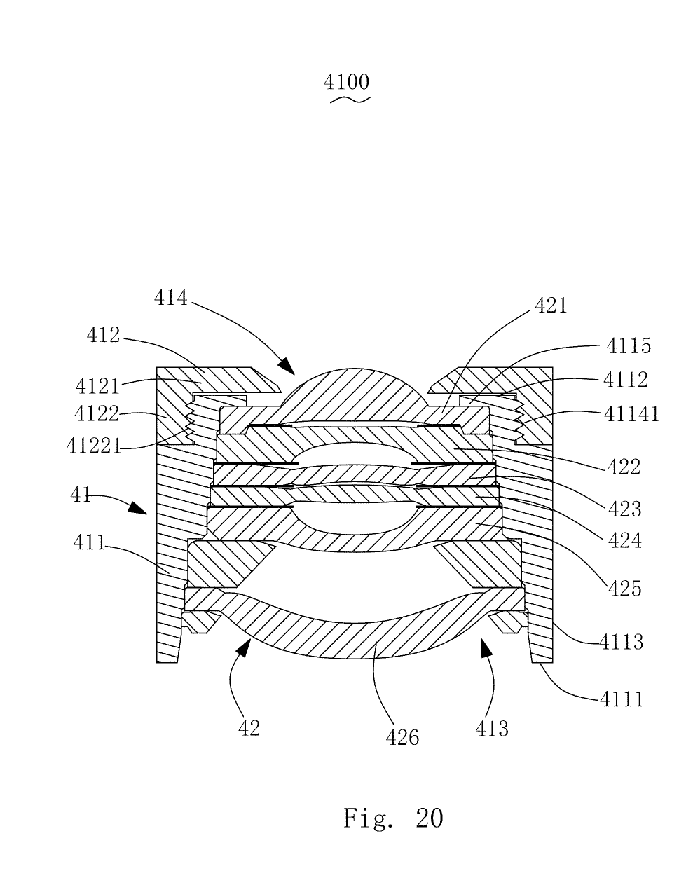

As shown in FIG. 20, the main wall 4121 of the second holder 412 keeps a distance from the pressing wall 4115 of the first holder 411, while, the auxiliary wall 4122 of the second holder 412 abuts against the second wall 41143 of the recess 4114.

Form 4

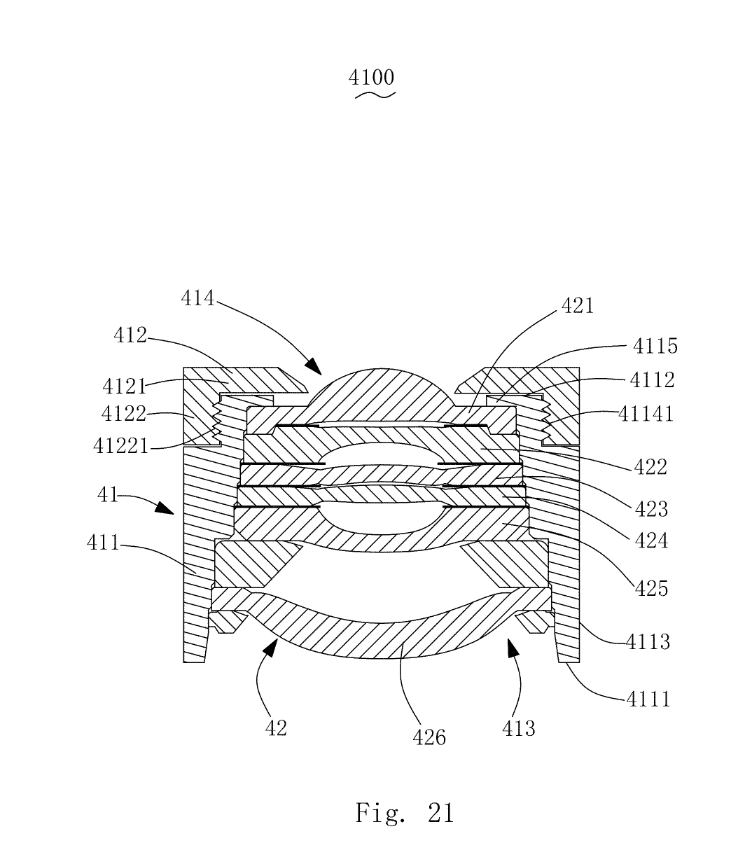

As shown in FIG. 21, the main wall 4121 of the second holder 412 keeps a distance from the pressing wall 4115 of the first holder 411, while, the auxiliary wall 4122 of the second holder 412 keeps a distance from the second wall 41143 of the recess 4114.

### Eighth Embodiment

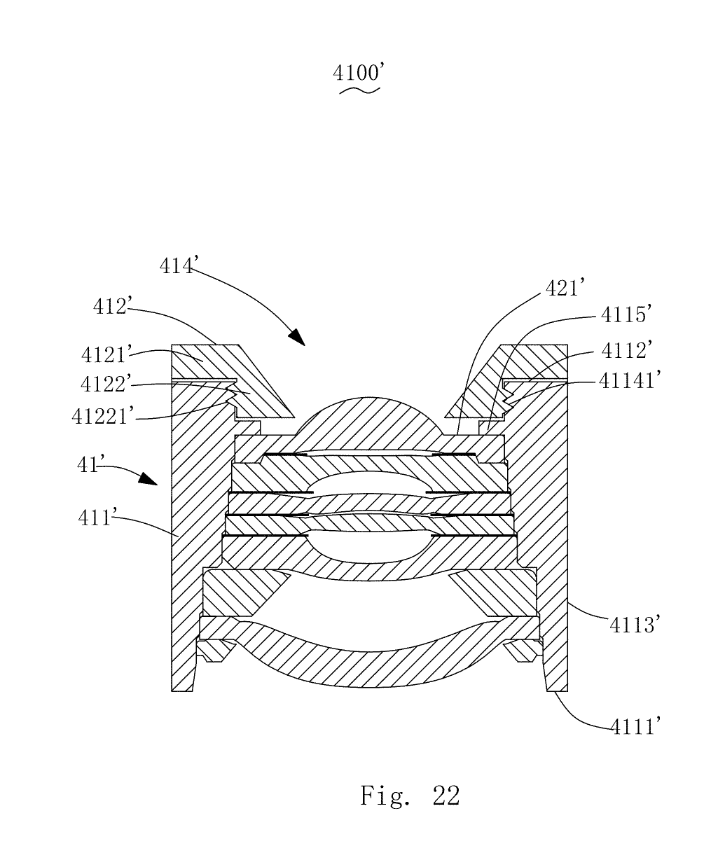

Referring to FIG. 22, the first holder 411′ of the lens holder 41′ includes a bottom surface 4111′, a top surface 4112′ opposite to the bottom surface 4111′, a side surface 4113′ adjacent to the accommodation space for connecting the top surface 4112′ to the bottom surface 4112′, and a pressing wall 4115′ extending from the side surface 4113′ for pressing on the first lens unit 421′. The first thread portion 41141′ is formed on the side surface 4113′ near the accommodation space. The first thread portion 41141′ is provided with an internal thread.

The second holder 412′ includes a main wall 4121′ with a light aperture 414′ and an auxiliary wall 4122′ extending perpendicularly from the main wall 4121′. The main wall 4121′ covers the top surface 4111′ of the first holder 411′. The auxiliary wall 4122′ abuts against the side surface 4113′ adjacent to the accommodation space, and the second thread portion 41221′ is formed on the auxiliary wall 4122′. The second thread portion 41221′ is provided with an external thread.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A camera lens, comprising:
a lens holder including a first holder and a second holder covering the first holder, the second holder having a light aperture;
an accommodation space formed by the first holder and the second holder;
a first lens unit accommodated in the accommodation space, and having an object side surface abutted against by the second holder; wherein
the first holder includes a first complementary configuration, and the second holder includes a second complementary configuration for engaging with the first complementary configuration for assembling the first holder with the second holder.

2. The camera lens as described in claim 1, wherein the first holder includes a bottom surface, a top surface opposite to the bottom surface, a side surface connecting the bottom surface and the top surface, and a recess, the first complementary configuration is in the recess; the second holder includes a main side and an auxiliary side extending perpendicularly from the main side; the second complementary configuration is formed on the auxiliary side.

3. The camera lens as described in claim 2, wherein the recess is formed by a first wall connecting with the top surface, a second wall extending from the first wall perpendicularly; the first complementary configuration is formed on the first wall, and the second complementary configuration is formed on a side of the second holder adjacent to the first wall.

4. The camera lens as described in claim 3, wherein the first lens unit is positioned by the first holder and the object side surface of the first lens unit is nearer the main wall of the second holder than the top surface of the first holder; the main side of the second holder abuts against the object side surface and keeps a distance from the top surface.

5. The camera lens as described in claim 4, wherein the auxiliary side of the second holder keeps a distance from the second wall of the recess.

6. The camera lens as described in claim 1, wherein the first holder includes a bottom surface, a top surface opposite to the bottom surface, and a side surface adjacent to the accommodation space for connecting the top surface to the bottom surface, the first complementary configuration is formed on the side surface; the second holder includes a main side with a light aperture and an auxiliary side extending perpendicularly from the main side, the main side covers the top surface, the auxiliary side abuts against the object side surface, and the second complementary configuration is formed on the auxiliary side.

7. The camera lens as described in claim 6, wherein the first lens unit is positioned in the first holder, and the auxiliary side of the second holder abuts against the object side surface for keeping the main side of the second holder a distance from the top surface of the first holder.

8. The camera lens as described in claim 1, wherein one of the first and second complementary configurations is a slot, and the other is a protrusion engaging with the slot.

9. The camera lens as described in claim 1, wherein one of the first and second complementary configurations is a thread portion provided with an external thread, and the other is a thread portion provided with an internal thread.

10. The camera lens as described in claim 1 further including a pressing ring located on an image side surface which is opposite to the object side surface for positioning the first lens unit.

11. A camera lens, comprising:
a lens holder including a first holder and a second holder covering the first holder, the second holder having a light aperture;
an accommodation space formed by the first holder and the second holder;
a first lens unit accommodated in the accommodation space, and having an object side surface abutted against by the first holder; wherein
the first holder includes a first complementary configuration, and the second holder includes a second complementary configuration for engaging with the first complementary configuration for assembling the first holder with the second holder.

12. The camera lens as described in claim 11, wherein the first holder includes a bottom surface, a top surface opposite to the bottom surface, a side surface connecting the bottom surface and the top surface, a pressing wall extending from the top surface toward the accommodation space for abutting against the object side surface of the first lens unit, and a recess; the first complementary configuration is in the recess; the second holder includes a main side and an auxiliary side extending perpendicularly from the main side; the second complementary configuration is formed on the auxiliary side; and the auxiliary side at least partially locates in the recess.

13. The camera lens as described in claim 12, wherein the recess is formed by a first wall connecting with the top surface, a second wall extending from the first wall perpendicularly; the first complementary configuration is formed on the first wall, and the second complementary configuration is formed on a side of the second holder adjacent to the first wall.

14. The camera lens as described in claim 13, wherein the main side of the second holder abuts against the pressing wall of the first holder, and the auxiliary side abuts against the second wall of the recess.

15. The camera lens as described in claim 13, wherein the main side of the second holder abuts against the pressing wall of the first holder, and the auxiliary side keeps a distance from the second wall of the recess.

16. The camera lens as described in claim 13, wherein the main side of the second holder keeps a distance from the pressing wall of the first holder, and the auxiliary side abuts against the second wall of the recess.

17. The camera lens as described in claim 13, wherein the main side of the second holder keeps a distance from the pressing wall of the first holder, and the auxiliary side keeps a distance from the second wall of the recess.

18. The camera lens as described in claim 11, wherein the first holder includes a bottom surface, a top surface opposite to the bottom surface, a side surface connecting the bottom surface and the top surface, and a pressing wall extending from the side surface toward the accommodation space for abutting against the object side surface of the first lens unit; the first complementary configuration is formed on the side surface; the second holder includes a main side covering the top surface of the first holder and an auxiliary side extending perpendicularly from the main side for covering the pressing wall; the second complementary configuration is formed on the auxiliary side.

19. The camera lens as described in claim 18, wherein the auxiliary side abuts against the pressing wall, and the main side of the second holder abuts against or keeps a distance from the top surface of the first holder.

20. The camera lens as described in claim 18, wherein the auxiliary side keeps a distance from the pressing wall, and the main side of the second holder abuts against or keeps a distance from the top surface of the first holder.

21. The camera lens as described in claim 11, wherein one of the first and second complementary configurations is a slot, and the other is a protrusion engaging with the slot.

22. The camera lens as described in claim 11, wherein one of the first and second complementary configurations is a thread portion provided with an external thread, and the other is a thread portion provided with an internal thread.

23. The camera lens as described in claim 11 further including a pressing ring located on an image side surface which is opposite to the object side surface for positioning the first lens unit in the lens holder.
